(19) United States
(12) Patent Application Publication
(10) Pub. No.: US 2010/0141607 A1
(43) Pub. Date: Jun. 10, 2010

(54) APPARATUS AND METHOD FOR RECOGNIZING MULTI TOUCH POINT

(75) Inventors: Dongwan RYOO, Daejeon-city (KR); Changseok BAE, Daejeon-city (KR); Jintae KIM, Daejeon-city (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejeon-city (KR)

(21) Appl. No.: 12/627,137

(22) Filed: Nov. 30, 2009

(30) Foreign Application Priority Data
Dec. 4, 2008 (KR) 10-2008-0122296
Aug. 12, 2009 (KR) 10-2009-0074384

(51) Int. Cl. G06F 3/043

(52) U.S. Cl. 345/177; 178/18.04

(57) ABSTRACT

The present invention relates to an apparatus and method for recognizing multi touch points. When touch input units are touched at the same time by a plurality of touch units, a plurality of sensors sense vibration signals generated from each touch point and measures intersection points from distance information of signals combined according to an input sequence to recognize positions of each touch point. The present invention can accurately recognize the coordinates of the touch points using a simple structure that the sensors are disposed at the edges of the touch input devices and thus, achieves a rapid response. In addition, with the present invention, it can recognize the coordinates of the touch points without limiting the size of the touch panel and when the touch points are generated at the same time, can accurately and rapidly recognize all the plurality of touch points.

### RELATED APPLICATIONS

The present application claims priority to Korean Patent Application Serial Number 10-2008-0122296, filed on Dec. 4, 2008 and Korean Patent Application Serial Number 10-2009-0074384, filed on Aug. 12, 2009, the entirety of which are hereby incorporated by reference.

### BACKGROUND OF THE INVENTION

1. Field of the Invention

The present invention relates to an apparatus and method for recognizing multi touch points, and more specifically, to an apparatus and method for recognizing positions of multi touch points by sensing the vibration propagation time of vibration waves using vibration sensing sensors attached to edges of a touch input apparatus.

2. Description of the Related Art

Generally, a touch panel means a unit that can be touched by a finger, a touch pen, etc., to input desired items. Herein, examples of the touch panel may include a touch screen that can input desired items by touching a display device such as a liquid crystal display (LCD), a touch pad that is mainly used for a notebook, a digitizer or a tablet that is mainly used for graphic work, etc.

The touch panel may include a touch-type capacitive overlay scheme, a pressure-type resistive overlay scheme, a pressure-type surface acoustic wave scheme, a scanning infrared scheme, a piezoelectric scheme, etc., according to a unit that recognize coordinates and has been mainly used as an input device of a computer.

The capacitive overlay scheme is a scheme that searches the change in electric capacitance at a touch point, which occurs due to electric capacitance of a human body when a hand or a conductor touches a panel surface. However, the capacitive overlay scheme has a disadvantage in that the panel surface should be touched by a finger. The capacitive overlay scheme is not affected by external factors and has high transparency.

The resistive overlay scheme is a scheme that recognizes touched areas by switching conductive layers, which are disposed with respect to coordinates on patterns designated by a user, by a touch. Even thought the price of the resistive overlay is reasonable, there are disadvantages in that the resistive overlay scheme has low transparency and coated layers can be damaged by sharp objects, etc. However, the resistive touch screen panel is not affected by external factors, such as dust, water, etc.

The surface acoustic wave scheme uses a scheme that uses acoustic waves passing over the touch screen panel. The surface acoustic wave scheme absorbs some of the acoustic waves and recognizes the change in the acoustic waves when the panel is touched by a scheme using the acoustic waves. Presently, the surface acoustic wave scheme is the most advanced scheme than all the other schemes. However, there is a disadvantage in that the surface acoustic wave scheme can be damaged by external factors.

Finally, the piezoelectric scheme is a scheme that calculates a voltage difference occurring from a piezoelectric element.

However, in the case of the above-mentioned touch panel, sensors should be installed on the entire panel, thereby having high cost. In addition, the sensors should be on the entire panel, such that the larger the size, the more the cost increases. Therefore, there is a need to reduce costs.

Efforts to solve the above problem have recently been made, but a method, which is applied to a plurality of touch points, has not been proposed until now. Therefore, when there are the plurality of touch points, a need exists for a method to recognize positions of each touch point.

### SUMMARY OF THE INVENTION

The present invention proposes to solve the above problems. It is an object of the present invention to provide an apparatus and method for recognizing multi touch points capable of satisfying general conditions required for a touch panel, such as a simple structure, accurate coordinate recognition, rapid response, etc.

In addition, it is another object of the present invention to provide an apparatus and method for recognizing multi touch points capable of recognizing coordinates of touch points without limiting a size of a touch panel.

Further, it is yet another object of the present invention to provide an apparatus and method for recognizing multi touch points capable of recognizing all of the plurality of touch points when the plurality of touch points are generated at the same time.

In order to achieve the above objects, there is provided an apparatus for recognizing multi touch points according to the present invention, including: touch input unit; a vibration sensing unit including a plurality of sensors that are disposed on the touch input unit and sense vibration signals generated from each touch point when the touch input unit is simultaneously touched by a plurality of touch unit; a distance measurement unit that measures a distance between the plurality of sensors and each touch point from each vibration signal sensed by the plurality of sensors; and a touch point recognition unit that measures intersection points of each vibration signal according to the distance information measured by the distance measurement unit and recognizes positions of each touch points from the measured intersection points.

The touch point recognition unit generates a plurality of circular traces corresponding to the distance information on each vibration signal measured by the distance measurement unit.

The touch point recognition unit recognizes a point at which every circular trace centering on the each sensor is intersected.

The distance measurement unit measures a distance between the plurality of sensors and each touch point based on the propagation transfer time of the vibration signals.

The distance measurement unit uses a difference between time when the touch input unit is touched and the propagation transfer time of the vibration signal in order to measure the distance between the plurality of sensors and each touch point.

The apparatus for recognizing multi touch points further includes a touch time measurement unit that measures time when the touch input unit is touched by the plurality of touch units. At this time, the touch time measurement unit measures a touch start time by using the capacitance or conductivity of an electric signal measured from the touch input unit.

The touch input unit is formed in a polygonal shape. At this time, the touch input unit is formed in a quadrangular shape.

The plurality of sensors included in the vibration sensing units are disposed at the edges of the touch input units, respectively.

In order to achieve the objects of the invention, there is provided a method for recognizing multi touch points according to the present invention, including: when touch input units are touched at the same time by a plurality of touch units, sensing vibration signals generated from each touch point by a plurality of sensors; measuring a distance between the plurality of sensors and each touch point from each vibration signal sensed by the plurality of sensors; and measuring intersection points of each vibration signal according to the distance information measured in the measuring and recognizing positions of each touch points from the measured intersection points.

The recognizing include generating a plurality of circular traces corresponding to the distance information of each vibration signal measured in the measuring.

The recognizing recognizes a point at which every circular trace centering on the each sensor is intersected.

The measuring measures a distance between the plurality of sensors and each touch point based on the propagation transfer time of the vibration signals.

The measuring uses a difference between time when the touch input unit is touched and the propagation transfer time of the vibration signal in order to measure the distance between the plurality of sensors and each touch point.

The method for recognizing multi touch points further includes measuring time when the touch input unit is touched by the plurality of touch units.

The present invention can accurately recognize the coordinates of the touch points by using a simple structure that the sensors are disposed at the edges of the touch input devices and thus, satisfies the rapid response.

In addition, with the present invention, it can recognize the coordinates of the touch points without limiting the size of the touch panel and when the touch points are generated at the same time, can accurately and rapidly recognize all the plurality of touch points.

### BRIEF DESCRIPTION OF THE DRAWINGS

FIG. 1 is a diagram schematically showing a configuration of an apparatus for recognizing multi touch points according to an embodiment of the present invention;

FIG. 2 is a block diagram showing a configuration of the apparatus for recognizing multi touch points according to the embodiment of the present invention;

FIGS. 3 to 8 are exemplified diagrams referenced for explaining an operation of the apparatus for recognizing multi touch points according to an embodiment of the present invention; and

FIG. 9 is a flowchart showing an operational flow of the method for recognizing multi touch points according to the present invention.

### DETAILED DESCRIPTION OF THE PREFERRED EMBODIMENTS

Hereinafter, embodiments of the present invention will be described in detail with reference to the accompanying drawings.

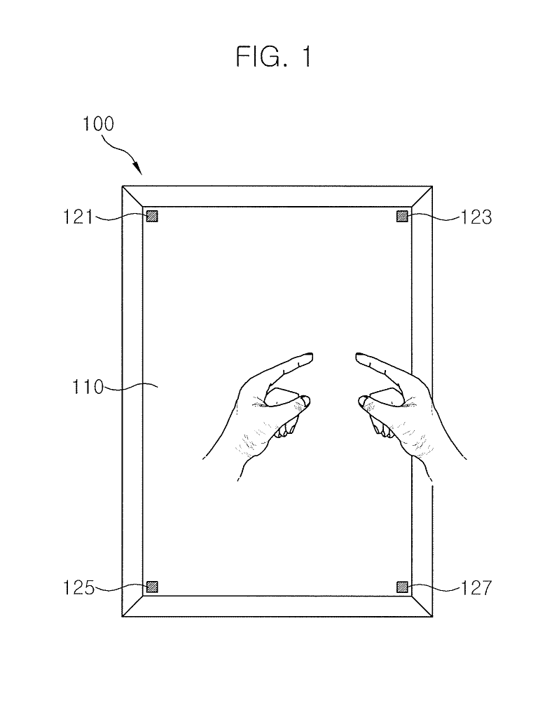

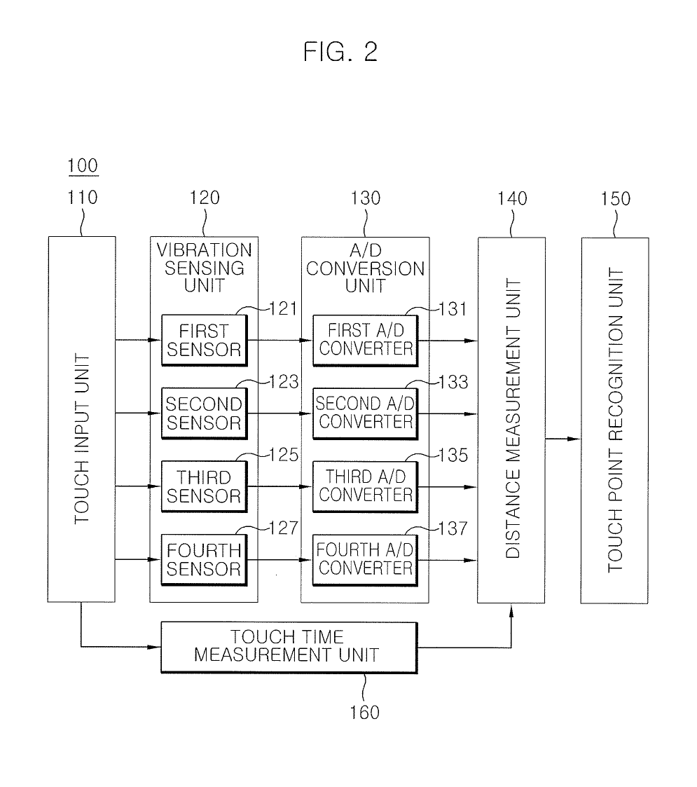

FIG. 1 is a diagram referenced for explaining a configuration of an apparatus for recognizing multi touch points according to the present invention and FIG. 2 is a block diagram schematically showing a configuration of an apparatus for recognizing multi touch points according to the present invention.

First, FIG. 1 shows a configuration of a touch input unit, which is touched by a user, in an apparatus for recognizing multi touch points of the present invention. Herein, the touch input unit 110 may be a display device. Of course, the touch input unit is not limited thereto and can be applied to all components, which can be touched, such as a protection filter, a floor panel in the interior and exterior of a room, a floor paper, etc.

As shown in FIG. 1, when a user simultaneously touches a plurality of points on a touch input unit 110 by using his/her hand, sensors, which are disposed at each of the edges of the touch input unit 110, sense vibration signals from each touch point. Therefore, an apparatus for recognizing multi touch points according to the present invention recognizes positions of the corresponding touch points based on the vibration signals sensed by each sensor.

Since the present invention does not need to dispose the sensors on the entire touch input unit as in the known touch panel, manufacturing costs of the apparatus for recognizing multi touch points can be significantly reduced and the apparatus for recognizing multi touch points can be used regardless of the size of the touch input unit.

The configuration of the apparatus for recognizing multi touch points shown in FIG. 1 will be described in more detail with reference to FIG. 2.

The apparatus for recognizing multi touch points according to the present invention includes the touch input unit 110, a vibration sensing unit 120, an A/D conversion unit 130, a distance measurement unit 140, and a touch point recognition unit 150, as shown in FIG. 2.

The touch input unit 110 is formed to have a polygonal shape, preferably, in a quadrangular shape. At this time, the size of the touch input unit 110 is not limited and therefore, the touch input unit from a small size to a large size can be applied.

The vibration sensing unit 120 includes a plurality of sensors, that is, a first sensor 121, a second sensor 123, a third sensor 125, and a fourth sensor 127. Each of the sensors is a vibration sensing sensor and disposed at each edge of the touch input unit 110, such that it senses the vibration signals generated when the touch input unit 110 is touched by the user. At this time, each sensor senses all the vibration signals generated from each touch point.

The A/D conversion unit 130 converts the signals sensed by each sensor of the vibration sensing unit 120 into digital signals and transfers the converted signals to the distance measurement unit 140. Herein, the A/D conversion unit 130 includes a plurality of A/D converter 130, that is, a first A/D converter 131, a second A/D converter 133, a third A/D converter 135, and a fourth A/D converter 137. At this time, the number of each A/D converters 131, 133, 135, and 137 provided correspond to the number of each sensors 121, 123, 125, and 127 in the vibration sensing unit 120 and each A/D converter 131, 133, 135, and 137 is connected corresponding to each sensor 121, 123, 125, and 127 in the vibration sensing unit 120. When the distance measurement unit 140 receives signals from each A/D conversion unit 130, it measures the propagation transfer time of signals input to each A/D conversion unit 130. The distance measurement unit 140 measure each propagation transfer time of the signals input through each A/D conversion unit 130 for each signal sensed from each sensor.

Meanwhile, the apparatus for recognizing multi touch points according to the present invention may further include a touch time measurement unit 160 that measures time when the touch input unit 100 is touched by the plurality of touch units, in order to measure the propagation transfer time of each vibration time.

Herein, the touch time measurement unit 160 measures a touch start time using the capacitance or conductivity of each vibration signal measured when the touch input unit 110 is touched.

Then, the distance measurement unit 140 measures the distance between each sensor and at least two touch points from each combined signal. At this time, the distance measurement unit 140 calculates the vibration propagation time of each signal to be measured. Alternatively, the distance measurement unit 140 calculates the distance based on the sensed time of the vibration signals of each sensor from the touch time of the touch input unit 110. Of course, the method for measuring the distance between each sensor from the touch point is not limited to any one method. Therefore, the distance can be measured by using a method for measuring a distance from the known receiving signals. At this time, assume that the vibration signals generated from each touch point are not interfered with other signals until they are transferred to each sensor.

When the distance measurement of each vibration signal sensed by each sensor is completed, the distance measurement unit 140 transfers the corresponding information to the touch point recognition unit 150.

When the touch point recognition unit 150 receives the distance information of vibration signals for each sensor measured by the distance measurement unit 140, it recognizes the intersection points between each vibration signal based on the distance information of each vibration signal.

At this time, the touch point recognition unit 150 generates a plurality of circular traces corresponding to the distance information of each vibration signal measured by the distance measurement unit 140. Herein, the touch point recognition unit 150 recognizes a point at which the plurality of circular traces are intersected, thereby recognizing the intersection points between each vibration signal. In detail, the touch point recognition unit 150 recognizes a point at which every circular trace centering on the each sensor is intersected.

For example, when the number of touch points is a total of three, the vibration signals generated from each touch point are transferred to each sensor. Each sensor receives the vibration signals generated by three touch points. Therefore, the touch point recognition unit 150 generates a total of 12 circular traces corresponding to the distance information on three vibration signals for each sensor. At this time, when the touch point recognition unit 150 recognizes a point at which all the circular traces according to the distance information of any one of the vibration signals input to each sensor are intersected, that is, when the touch point recognition unit 150 includes four sensors, the point where all four circular traces are intersected based on sensors A, B, C, and D.

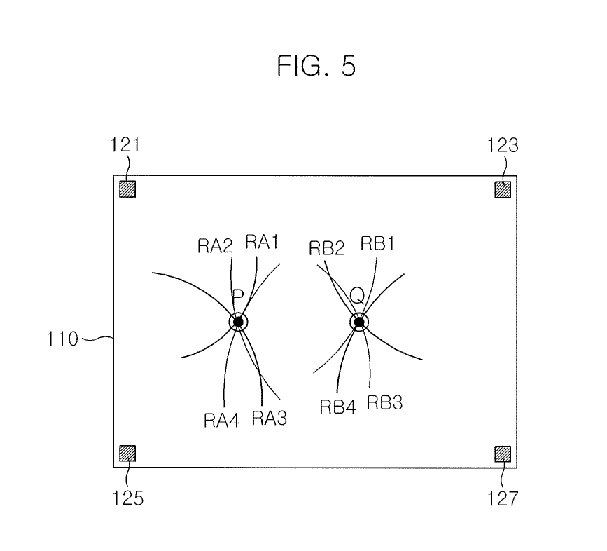

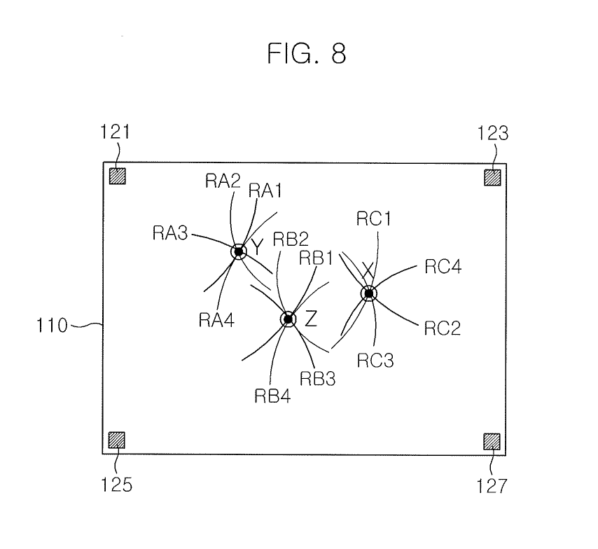

In this case, the points where all four circular traces intersect is a total of three. The touch point recognition unit 150 recognizes the intersected points at that time as the touch points. The detailed embodiment thereof will be described with reference to FIGS. 5 and 8.

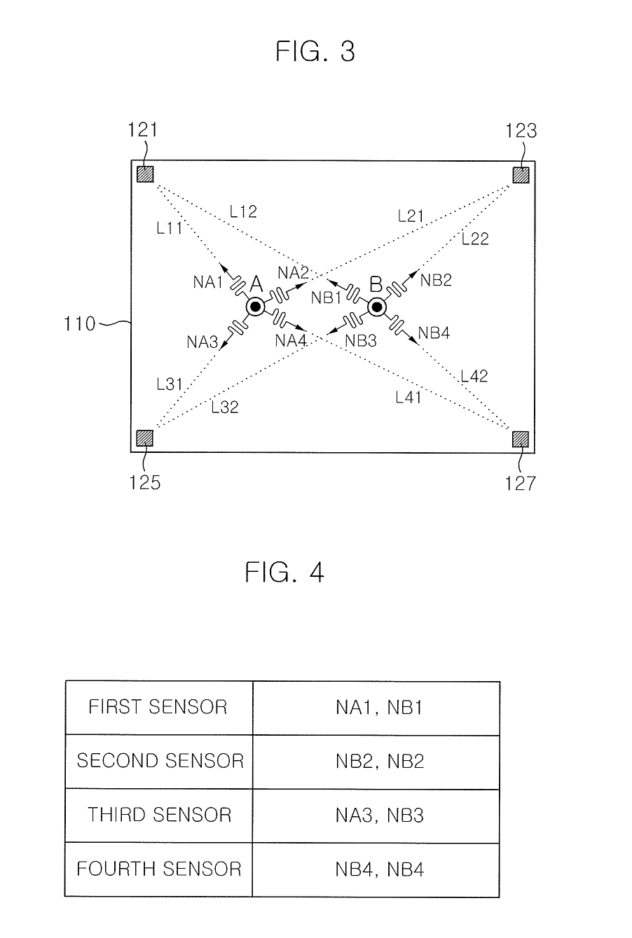

The apparatus for recognizing multi touch points according to the present invention configured as described above will be described with reference to FIGS. 3 to 8.

FIGS. 3 to 5 show an example of a case where the touch points are two.

First, as shown in FIG. 3, when A and B points of the touch input unit 110 are touched at the same time, the vibration signals are generated at the touch points A and B. At this time, the generated vibration signals are transferred to the sensors that are disposed at each edge of the touch input unit 100.

In other words, the vibration signals generated from multi touch point A are transferred to the first sensor 121, the second sensor 123, the third sensor 125, and the fourth sensor 127, respectively. At this time, among the vibration signals generated from touch point A, the vibration signal input to the first sensor 121 is referred to as NA1, the vibration signal input to the second sensor 123 is referred to as NA2, the vibration signal input to the third sensor 125 is referred to as NA3, and the vibration signal input to the fourth sensor 127 is referred to as NA4.

Likewise, the vibration signals generated from the touch point B are also transferred to the first sensor 121, the second sensor 123, the third sensor 125, and the fourth sensor 127, respectively. At this time, among the vibration signals generated from touch point B, the vibration signal input to the first sensor 121 is referred to as NB1, the vibration signal input to the second sensor 123 is referred to as NB2, the vibration signal input to the third sensor 125 is referred to as NB3, and the vibration signal input to the fourth sensor 127 is referred to as NB4.

At this time, assume that the vibration signals generated from touch point A and touch point B overlap with each other so as not to interfere with other signals.

FIG. 4 arranges the vibration signals input to each sensor.

In other words, the signals input to the first sensor 121 are NA1 and NB1. Meanwhile, the signals input to the second sensor 123 are NA2 and NB2. Meanwhile, the signals input to the third sensor 125 are NA3 and NB3. Also, the signals input to the fourth sensor 127 are NA4 and NB4.

At this time, the distance measurement unit 140 measures the transfer distance of the corresponding signals based on the signals input to each sensor.

In other words, the distance measurement unit 140 measures the signal transfer distance of the signals NA1 and NB1 input to the first sensor 121, respectively. In addition, the distance measurement unit 140 measures the signal transfer distance of the signals NA2 and NB2 input to the second sensor 123, respectively. Likewise, the distance measurement unit 140 measures the signal transfer distance of the signals NA3 and NB3 input to the third sensor 125, respectively. Finally, the distance measurement unit 140 measures the signal transfer distance of the signals NA4 and NB4 input to the fourth sensor 127, respectively.

Thereafter, the distance measurement unit 140 transfers the distance measurement results of the signals input to the first sensor 121, the second sensor 123, the third sensor 125, and the fourth sensor 127, respectively, to the touch point recognition unit 150.

The touch point recognition unit 150 measures the intersection points according to the distance of each signal based on the distance measurement results transferred from the distance measurement unit 140. The embodiment thereof will be described with reference to FIG. 5.

As shown in FIG. 5, the touch point recognition unit 150 generates the circular trace for each signal according to the measurement distance from the distance measurement unit 140. In other words, the touch point recognition unit 150 generates a circular trace RA1 according to the distance of the signal NA1 input to the first sensor 121 and a circular trace RB1 according to the distance of the signal NB1.

Further, the touch point recognition unit 150 generates a circular trace RA2 according to the distance of the signal NA2 input to the second sensor 123 and a circular trace RB2 according to the distance of the signal NB2. Further, the touch point recognition unit 150 generates a circular trace RA3 according to the distance of the signal NA3 input to the third sensor 125 and a circular trace RB3 according to the distance of the signal NB3. In addition, the touch point recognition unit 150 generates a circular trace RA4 according to the distance of the signal NA4 input to the fourth sensor 127 and a circular trace RB4 according to the distance of the signal NB4.

At this time, the touch point recognition unit 150 confirms the intersection points at which all circular traces corresponding to the signals from the first sensor 121, the second sensor 123, the third sensor 125, and the fourth sensor 127 are intersected.

In other words, the touch point recognition unit 150 confirms positions of intersection point P at which RA1, RA2, RA3, and RA4 intersect and intersection point Q at which RB1, RB2, RB3, and RB4 intersect. Herein, the position of the intersection point P corresponds to the touch point A and the position of the intersection point Q corresponds to the touch point B.

Thereby, when two touch points are given at the same time, the apparatus for recognizing multi touch points according to the present invention recognizes the positions of two touch points A and B by the above-mentioned method.

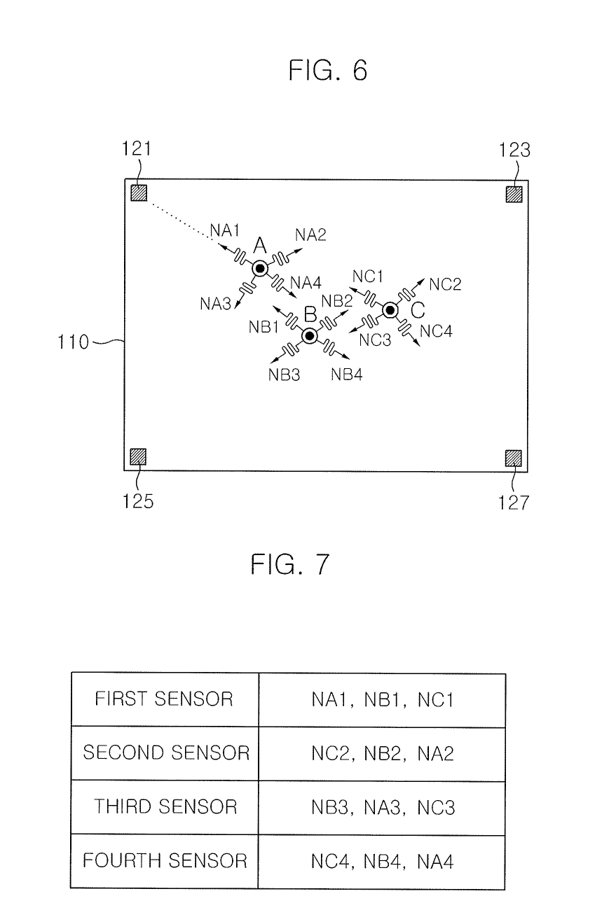

Meanwhile, FIGS. 6 to 8 show an example of a case when there are three touch points. This is also applied to a case where there are three or more touch points.

First, as shown in FIG. 6, when A, B, and C points of the touch input unit 110 are touched at the same time, the vibration signals are generated at touch points A, B, and C. At this time, the generated vibration signals are transferred to the sensors that are disposed at each edge of the touch input unit 100.

In other words, the vibration signals generated from the touch point A are transferred to the first sensor 121, the second sensor 123, the third sensor 125, and the fourth sensor 127, respectively. At this time, all the vibration signals generated from the touch point A are transferred to each sensor in the same waveform, but in the embodiment of FIG. 6, the vibration signal input to the first sensor 121 is referred to as NA1, the vibration signal input to the second sensor 123 is referred to as NA2, the vibration signal input to the third sensor 125 is referred to as NA3, and the vibration signal input to the fourth sensor 127 is referred to as NA4, for convenience's sake.

Likewise, the vibration signals generated from touch point B are also transferred to the first sensor 121, the second sensor 123, the third sensor 125, and the fourth sensor 127, respectively. At this time, all the vibration signals generated from touch point B are transferred to each sensor in the same waveform, but in the embodiment of FIG. 6, the vibration signal input to the first sensor 121 is referred to as NB1, the vibration signal input to the second sensor 123 is referred to as NB2, the vibration signal input to the third sensor 125 is referred to as NB3, and the vibration signal input to the fourth sensor 127 is referred to as NB4, for convenience's sake.

Meanwhile, the vibration signals generated from touch point C are also transferred to the first sensor 121, the second sensor 123, the third sensor 125, and the fourth sensor 127, respectively. At this time, all the vibration signals generated from the touch point C are transferred to each sensor in the same waveform, but in the embodiment of FIG. 6, the vibration signal input to the first sensor 121 is referred to as NC1, the vibration signal input to the second sensor 123 is referred to as NC2, the vibration signal input to the third sensor 125 is referred to as NC3, and the vibration signal input to the fourth sensor 127 is referred to as NC4, for convenience's sake.

At this time, assume that the vibration signals generated from touch points A, B, and C overlap with each other so as not to interfere with other signals.

FIG. 7 arranges the vibration signals input to each sensor.

In other words, the signal input to the first sensor 121 is NA1, NB1, and NC1. Meanwhile, the signals input to the second sensor 123 are NA2, NB2, and NC2. Meanwhile, the signals input to the third sensor 125 are NA3, NB3, and NC3. Also, the signals input to the fourth sensor 127 are NA4, NB4, and NC4.

At this time, the distance measurement unit 140 measures the transfer distance of the corresponding signals based on the signals input to each sensor.

In other words, the distance measurement unit 140 measures the signal transfer distance of the signals NA1 and NB1 input to the first sensor 121, respectively. In addition, the distance measurement unit 140 measures the signal transfer distance of signals NA2 and NB2 input to the second sensor 123, respectively. Likewise, the distance measurement unit 140 measures the signal transfer distance of signals NA3 and NB3 input to the third sensor 125, respectively. Finally, the distance measurement unit 140 measures the signal transfer distance of signals NA4 and NB4 input to the fourth sensor 127, respectively.

Thereafter, the distance measurement unit 140 transfers the distance measurement results of the signals input to the first sensor 121, the second sensor 123, the third sensor 125, and the fourth sensor 127, respectively, to the touch point recognition unit 150.

The touch point recognition unit 150 measures the intersection points according to the distance of each signal based on the distance measurement results transferred from the distance measurement unit 140. The embodiment thereof will be described with reference to FIG. 8.

As shown in FIG. 8, the touch point recognition unit 150 generates the circular trace for each signal according to the measurement distance from the distance measurement unit 140. In other words, the touch point recognition unit 150 generates the circular trace RA1 according to the distance of the signal NA1 input to the first sensor 121, the circular trace RB1 according to the distance of the signal NB1, and the circular distance RC1 according to the distance of the signal NC1. Further, the touch point recognition unit 150 generates the circular trace RA2 according to the distance of signal NA2 input to the second sensor 123, the circular trace RB2 according to the distance of signal NB2, and the circular trace RC2 according to the distance of signal NC2.

Further, the touch point recognition unit 150 generates the circular trace RA3 according to the distance of the signal NA3 input to the third sensor 125, the circular trace RB3 according to the distance of signal NB3, and the circular trace RC3 according to the distance of signal NC3. Further, the touch point recognition unit 150 generates the circular trace RA4 according to the distance of signal NA4 input to the second sensor 127, the circular trace RB4 according to the distance of signal NB4, and the circular trace RC4 according to the distance of signal NC4.

At this time, the touch point recognition unit 150 confirms the intersection points at which all circular traces corresponding to the signals from the first sensor 121, the second sensor 123, the third sensor 125, and the fourth sensor 127 are intersected.

In other words, the touch point recognition unit 150 confirms positions of an intersection point X at which RA1, RA2, RA3, and RA4 are intersected, an intersection point Y at which, RB1, RB2, RB3, and RB4 are intersected, and an intersection point Z at which RC1, RC2, RC3, and RC4 are intersected. Herein, the position of intersection point X corresponds to the touch point A, the position of intersection point Y corresponds to the touch point B, and the position of intersection point Z corresponds to the touch point C.

Thereby, when three touch points are given at the same time, the apparatus for recognizing multi touch points according to the present invention recognizes the positions of three touch points A, B, and C by the above-mentioned method. Consequently, when the touch points more than the above touch points are given at the same time, the apparatus for recognizing multi touch points can recognize all the corresponding touch points by the same method.

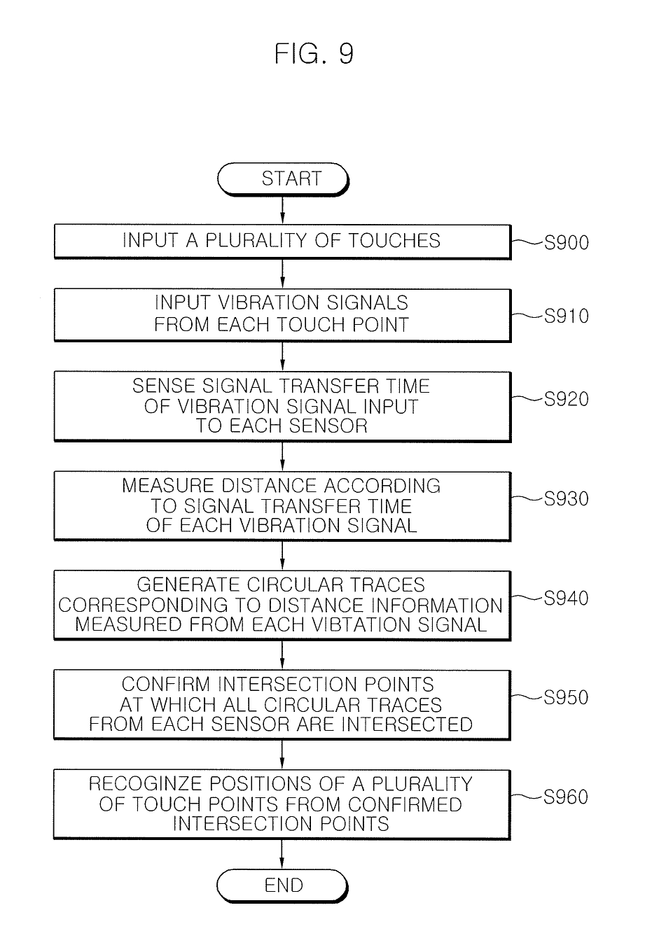

An operational flow of the method for recognizing multi touch points according to the present invention configured as described above will be described as follows. FIG. 9 is a flowchart showing an operational flow of the method for recognizing multi touch points according to the present invention.

First, when the touch input units 110 are touched by the plurality of touch units (for example, touch pen, finger, etc.) (S900), the vibration signals are generated from the plurality of touch points. At this time, the first sensor 121 to the fourth sensor 127, which are disposed at each edge of the touch input unit 110, receive the vibration signals generated from the plurality of touch points (S910).

The signals input to each sensor are converted into digital signals in an input sequence by the A/D conversion unit 130 and are transferred to the distance measurement unit 140. The distance measurement unit 140 senses the signal propagation time of the vibration signals input to each sensor (S920) and measures the transfer distance of each signal based on the signal propagation time (S930).

At this time, the distance measurement unit 140 outputs the measured distance data to the touch point recognition unit 150 (S960). Therefore, the touch point recognition unit 150 generates the circular traces corresponding to the distance information measured from each vibration signal based on the distance information from the distance measurement unit 140 (S940).

Thereafter, the touch point recognition unit 150 confirms the intersection points at which all circular traces corresponding to the signals from the first sensor 121, the second sensor 123, the third sensor 125, and the fourth sensor 127 are intersected (S950).

Finally, the touch point recognition unit 150 recognizes the positions of the plurality of touch points from the intersection points confirmed in step “S950” (S960).

As described above, the apparatus and method for recognizing multi touch points according to the present invention is not limited to the configuration and method of the embodiments described as above, but the embodiments may be configured by selectively combining all the embodiments or some of the embodiments so that various modifications can be made.

What is claimed is:

1. An apparatus for recognizing multi touch points comprising:
touch input units;
a vibration sensing unit including a plurality of sensors that are disposed on the touch input units and sense vibration signals generated from each touch point when the touch input units are simultaneously touched by a plurality of touch units;
a distance measurement unit that measures a distance between the plurality of sensors and each touch point from each vibration signal sensed by the plurality of sensors; and
a touch point recognition unit that measures intersection points of each vibration signal according to the distance information measured by the distance measurement unit and recognizes positions of each touch points from the measured intersection points.

2. The apparatus for recognizing multi touch points according to claim 1, wherein the touch point recognition unit generates a plurality of circular traces centering on the each sensor, corresponding to the distance information on each vibration signal measured by the distance measurement unit.

3. The apparatus for recognizing multi touch points according to claim 2, wherein the touch point recognition unit recognizes a point at which every circular trace centering on the each sensor is intersected.

4. The apparatus for recognizing multi touch points according to claim 1, wherein the distance measurement unit measures a distance between the plurality of sensors and each touch point based on the propagation transfer time of the vibration signals.

5. The apparatus for recognizing multi touch points according to claim 1, wherein the distance measurement unit uses a difference between time when the touch input unit is touched and the propagation transfer time of the vibration signal to measure the distance between the plurality of sensors and each touch point.

6. The apparatus for recognizing multi touch points according to claim 1, further comprising a touch time measurement unit that measures time when the touch input unit is touched by the plurality of touch units.

7. The apparatus for recognizing multi touch points according to claim 6, wherein the touch time measurement unit measures a touch start time by using the capacitance or conductivity of an electric signal measured from the touch input unit.

8. The apparatus for recognizing multi touch points according to claim 1, wherein the touch input unit is formed in a polygonal shape.

9. The apparatus for recognizing multi touch points according to claim 8, wherein the touch input unit is formed in a quadrangular shape.

10. The apparatus for recognizing multi touch points according to claim 8, wherein the plurality of sensors included in the vibration sensing units are disposed at edges of the touch input unit, respectively.

11. A method for recognizing multi touch points comprising:
when touch input unit is touched at the same time by a plurality of touch units, sensing vibration signals generated from each touch point by a plurality of sensors;
measuring a distance between the plurality of sensors and each touch point from each vibration signal sensed by the plurality of sensors; and
measuring intersection points of each vibration signal according to the distance information measured in the measuring and recognizing positions of each touch points from the measured intersection points.

12. The method for recognizing multi touch points according to claim 11, wherein the measuring intersection points includes generating a plurality of circular traces corresponding to the distance information of each vibration signal measured in the measuring.

13. The method for recognizing multi touch points according to claim 12, wherein the recognizing recognizes a point at which every circular trace centering on the each sensor is intersected.

14. The method for recognizing multi touch points according to claim 11, wherein the measuring measures a distance between the plurality of sensors and each touch point based on the propagation transfer time of the vibration signals.

15. The method for recognizing multi touch points according to claim 11, wherein the measuring uses a difference between time when the touch input unit is touched and the propagation transfer time of the vibration signal to measure the distance between the plurality of sensors and each touch point.

16. The method for recognizing multi touch points according to claim 11, further comprising measuring time when the touch input unit is touched by the plurality of touch units.
